(19) United States
(12) Patent Application Publication
(10) Pub. No.: US 2022/0066652 A1
(43) Pub. Date: Mar. 3, 2022

(54) PROCESSING DATA BEFORE RE-PROTECTION IN A DATA STORAGE SYSTEM

(71) Applicant: EMC IP Holding Company LLC, Hopkinton, MA (US)

(72) Inventors: Mikhail Danilov, Saint Petersburg (RU); Konstantin Buinov, Prague (CZ)

(21) Appl. No.: 17/008,704

(22) Filed: Sep. 1, 2020

(51) Int. Cl. G06F 3/06; G06F 11/14

(52) U.S. Cl. CPC G06F 3/0619; G06F 3/0608; G06F 3/0652; G06F 11/1435; G06F 3/067; G06F 3/0683; G06F 3/064

(57) ABSTRACT

The technology described herein is directed towards processing data that is protected by a preliminarily protection scheme (e.g., triple mirroring) before re-protecting that data via erasure coding. Data of new or updated objects, which can be segmented in one or more preliminarily protected data chunks (a data inbox), is consolidated to put the object's data segments in contiguous space. The consolidated object data can be compressed, and erasure coded (possibly along with consolidated and compressed data of one or more other objects) into data fragments and coding fragments of a distributed destination data chunk. Once an object is stored via erasure coding, the source chunk or chunks no longer contain live data of that object; when a source chunk contains no live data of any object, the capacity of the source chunk (and any mirror copies) can be reclaimed.

### TECHNICAL FIELD

The subject application generally relates to data storage, and, for example, to a data storage system that processes object data when re-protecting the data using an erasure coding protection scheme from a preliminary protection scheme, and related embodiments.

### BACKGROUND

Contemporary cloud-based data storage systems, such as ECS (formerly known as ELASTIC CLOUD STORAGE) provided by DELL EMC, store data in a way that ensures data protection while retaining storage efficiency. In ECS, object data is stored in storage units referred to as chunks, with one chunk typically storing the object data of multiple objects. Chunk content is modified in append-only mode. When a chunk becomes full enough, the chunk gets sealed and can no longer be written to with further data. The content of a sealed chunk is immutable.

ECS is a reliable storage, including that erasure coding is used to protect user data at the chunk level. However, chunks are filled with user data at different rates, whereby in general it is difficult to predict the moment when a given chunk will get sealed. During data writes for a client, the data storage system does not send any acknowledgement to the client until the data is properly protected in a non-volatile memory. Therefore, there is a time window between the moment the user data comes into the system and the moment that the chunk gets sealed so that the chunk's content can be encoded.

During this time window, triple mirroring can be used as a preliminary protection scheme before erasure coding occurs; in other words, delayed erasure coding is implemented. Note that with triple mirroring, three mirror copies of a chunk are stored to different nodes (which can be two complete copies and one composite copy comprising k data fragments). Therefore, with triple mirroring the system can tolerate dual-node failure until data re-protection via delayed erasure coding can be performed.

Once erasure coding is performed and a triple-mirrored chunk contains no live object data, the triple-mirrored chunk space can be reclaimed. However, even after erasure coding, a user data chunk tends to store relatively small segments of a plurality of data objects, which complicates and slows down reclamation of capacity corresponding to deleted objects.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of part of a data storage system including nodes, in which preliminary protected object data is processed and erasure encoded to distributed destination chunk fragments, in accordance with various aspects and implementations of the subject disclosure.

FIG. 2 is a representation of consolidating data of various objects to prepare for being encoded into distributed destination chunk fragments, in accordance with various aspects and implementations of the subject disclosure.

FIG. 3 is a representation of example chunks containing an object's segments being processed for erasure encoding into distributed destination chunk fragments, in accordance with various aspects and implementations of the subject disclosure.

FIG. 4 is a representation of compressing data of consolidated objects to prepare for being encoded into distributed destination chunk fragments, in accordance with various aspects and implementations of the subject disclosure.

FIG. 5 is a representation of how data and coding fragment space can be pre-allocated in a distributed chunk space, in accordance with various aspects and implementations of the subject disclosure.

FIGS. 6 and 7 comprise a flow diagram representing example operations for processing objects for erasure encoding to distributed destination chunk fragments, and related operations, in accordance with various aspects and implementations of the subject disclosure.

FIG. 8 is a flow diagram showing example operations related to consolidating and compressing object data for erasure encoding, in accordance with various aspects and implementations of the subject disclosure.

FIG. 9 is a flow diagram showing example operations related to consolidating and compressing object data for storing in a distributed chunk data structure, in accordance with various aspects and implementations of the subject disclosure.

FIG. 10 is a flow diagram showing example operations related to consolidating compressing and erasure coding object data for storing in a distributed chunk data structure, in accordance with various aspects and implementations of the subject disclosure.

FIG. 11 depicts an example schematic block diagram of a computing environment with which the disclosed subject matter can interact, in accordance with various aspects and implementations of the subject disclosure.

FIG. 12 illustrates an example block diagram of a computing system operable to execute the disclosed systems and methods in accordance with various aspects and implementations of the subject disclosure.

### DETAILED DESCRIPTION

Various aspects of the technology described herein are generally directed towards performing additional processing of data before re-protection of the data using erasure coding. As will be understood, the technology described herein increases data storage efficiency without any significant impact on write performance.

In one aspect, the technology operates to consolidate object data. More particularly, the data that is preliminarily protected (e.g., via mirroring) is stored to different source (“data inbox”) chunks or to different parts of one data inbox chunk. Consolidating the different segments of object data into contiguous space before re-protecting that data improves data locality, whereby, for example, a garbage collector can reclaim chunk capacity faster and using simpler and less resource-demanding techniques. Data consolidation is based on reading the segments of an object from its one or more source inbox chunks and putting the segments together in their natural order whenever possible

The consolidated data can be stored to a sequence of destination chunks, which are configured to be directly with protected erasure coding. However, in another aspect, compression (e.g., using relatively deep compression techniques) can be performed on the consolidated data before the re-protection of the data via erasure coding into destination chunks, which can be protected directly with erasure coding.

As will be understood, the implementation(s) described herein are non-limiting examples, and variations to the technology can be implemented. For example, in ECS cloud storage technology a “chunk” is a data storage unit/structure in which data objects are stored together, garbage collected and so on; however any data storage unit/structure can be used, such as the data structures to maintain data in other data storage systems, and thus the term “chunk” is not limited to ECS storage technology, but rather represents any unit or block of storage. Indeed, it should be understood that any of the examples herein are non-limiting. For instance, some of the examples are based on ECS cloud storage technology; however virtually any storage system may benefit from the technology described herein. Thus, any of the embodiments, aspects, concepts, structures, functionalities or examples described herein are non-limiting, and the technology may be used in various ways that provide benefits and advantages in computing and data storage in general.

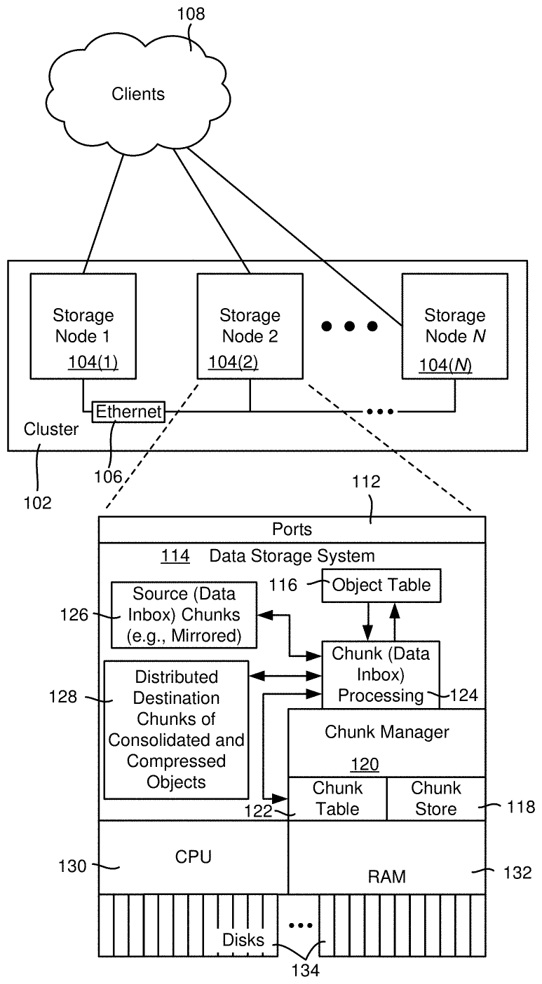

FIG. 1 shows part of a cloud data storage system such as ECS comprising a zone (e.g., cluster) 102 of storage nodes 104(1)-104(N), in which each node is typically a server configured primarily to serve objects in response to client requests. The nodes 104(1)-104(N) are coupled to each other via a suitable data communications link comprising interfaces and protocols, such as represented in FIG. 1 by Ethernet block 106.

Clients 108 make data system-related requests to the cluster 102, which in general is configured as one large object namespace; there may be on the order of billions of objects maintained in a cluster, for example. To this end, a node such as the node 104(2) generally comprises ports 112 by which clients connect to the cloud storage system. Example ports are provided for requests via various protocols, including but not limited to SMB (server message block), FTP (file transfer protocol), HTTP/HTTPS (hypertext transfer protocol) and NFS (Network File System); further, SSH (secure shell) allows administration-related requests, for example.

In general, and in one or more implementations, e.g., ECS, disk space is partitioned into a set of relatively large blocks of typically fixed size (e.g., 128 MB) referred to as chunks; user data is generally stored in chunks, e.g., in a user data repository. Normally, one chunk contains segments of several user objects. In other words, chunks can be shared, that is, one chunk may contain segments of multiple user objects; e.g., one chunk may contain mixed segments of some number of (e.g., three) user objects.

Each node, such as the node 104(2), includes an instance of a data storage system 114 and data services; (note however that at least some data service components can be per-cluster, or per group of nodes, rather than per-node). For example, ECS runs a set of storage services, which together implement storage business logic. Services can maintain directory tables for keeping their metadata, which can be implemented as search trees. A blob service can maintain an object table 116 that keeps track of objects in the data storage system 114 and generally stores the system objects' metadata, including an object's data location within a chunk. Note that the object table 116 can be partitioned among the nodes 104(1)-104(N) of the cluster. There is also a “reverse” directory table (maintained by another service) that keeps a per chunk list of objects that have their data in a particular chunk.

FIG. 1 generalizes some of the above concepts, in that the user data repository of chunks is shown as a chunk store 118, managed by a chunk manager 120. A chunk table 122 maintains metadata about chunks, optionally including generation numbers as described herein, e.g., as one of a chunk's attributes.

Further, as described herein, chunk (data inbox) processing logic 124 is coupled to the chunk table 122 and the chunk manager 120 to determine source chunks 126 that are preliminarily protected (e.g., via mirroring) containing ready for data re-protection via erasure coding into distributed fragments in destination chunk or chunks 128, that is, data inbox chunks that are to be processed into distributed chunk fragments. The object table and chunk table are updated to track the location of the processed object data within the new destination chunks/fragments.

In FIG. 1, a CPU 130 and RAM 132 are shown; note that the RAM 132 may comprise at least some non-volatile RAM. The node includes storage devices such as disks 134, comprising hard disk drives and/or solid-state drives. As is understood, any node data structure such as an object, object table, chunk table, chunk, code, and the like can be in RAM 128, on disk(s) 130 or a combination of partially in RAM, partially on disk, backed on disk, replicated to other nodes and so on.

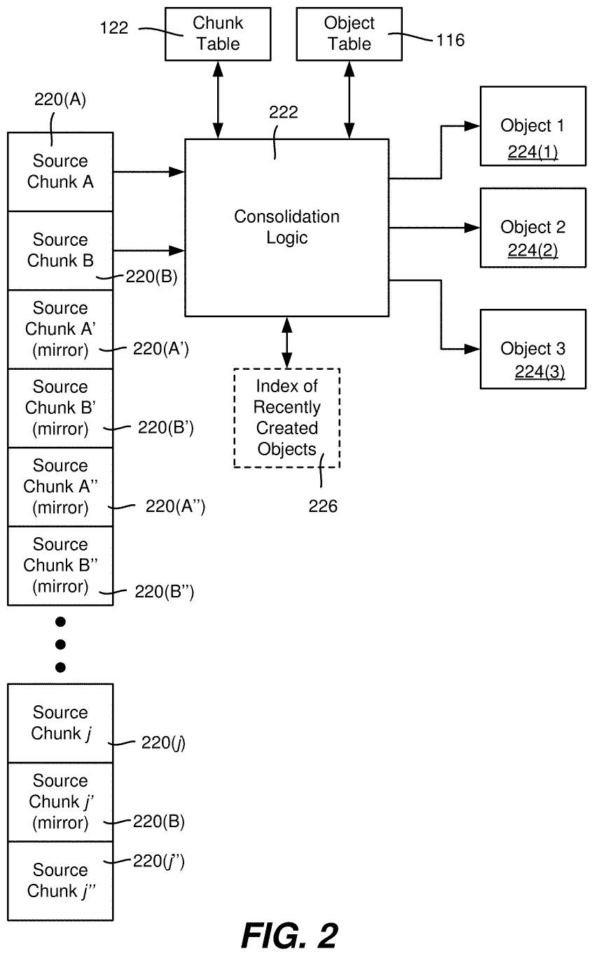

FIG. 2 shows a set of source, or data inbox chunks 220(A)-220(j″), which in this example are protected via triple mirroring. As described herein, consolidation logic 222 consolidates object data stored to different inbox chunks or to different parts of one inbox chunk. Note that the source chunks 220(A)-220(j″) are not in any particular order, and the consolidation logic 222 determines the objects' chunk identities from the object table 116 and the chunks' locations via the chunk table 122 (which can be indirectly obtained, e.g., via the chunk manager and so forth). In the example of FIG. 2, consider that three objects 1, 2 and 3 (blocks 224(1)-224(3)), respectively have their data consolidated.

Recently created objects are protected via the preliminary protection scheme, and thus such objects are used to drive the operations described herein. It should be noted that an optional (e.g., relatively lightweight) index 226 of recently created objects may be maintained to help implement the object-driven data processing described herein, such as object identifier, its size and its chunk(s); however the object table 116 still maintains the complete description of each object.

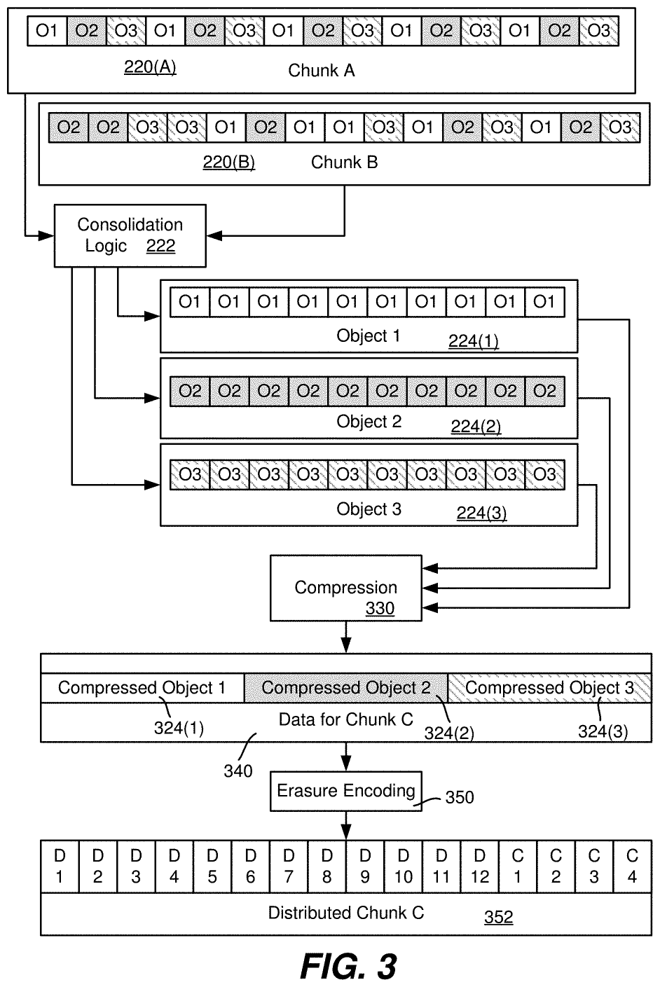

More particularly, FIG. 3 shows that the data segments of objects 224(1)-224(3) are initially located in chunk A 220(A) and chunk B 220(B). The consolidation logic 222 reads the segments of each object and puts them together (e.g., in an in-memory data structure) to form the three consolidated data objects (blocks 224(1)-224(3)). At this time, the data in the three consolidated data objects can be erasure coded into distributed data and coding fragments; however another aspect can further improve efficiency before erasure coding, namely data compression.

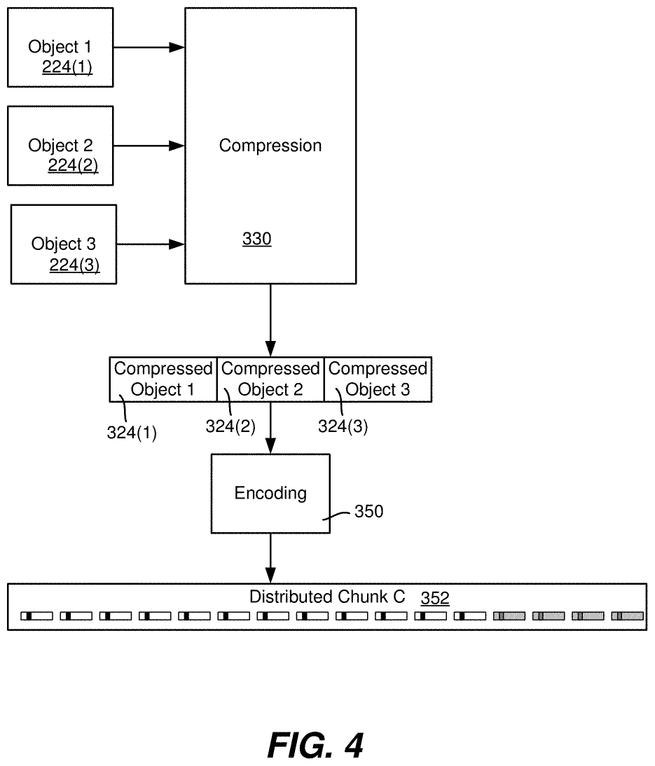

FIGS. 3 and 4 thus show a data compression 330 operation that can occur prior to encoding. In general, as in FIG. 4, the data of the objects (blocks 224(1)-224(3)) is compressed to form compressed objects 324(1)-324(3), respectively. Any suitable lossless data compression technique can be used, such as one that accomplishes fifty percent compression. The type of data can be considered when choosing a compression technique.

In the more particular example shown in FIG. 3, the compressed objects 324(1)-324(3) fit into the space 340 corresponding to a single data chunk C: e.g., not necessarily exactly, but at least reaching a capacity used threshold value. At this time, the compressed data in the space 340 can be erasure coded (block 350) into the data fragments and coding fragments of the erasure coding scheme, e.g., twelve data fragments D1-D12 and four coding fragments C1-C4 of a distributed chunk C 352.

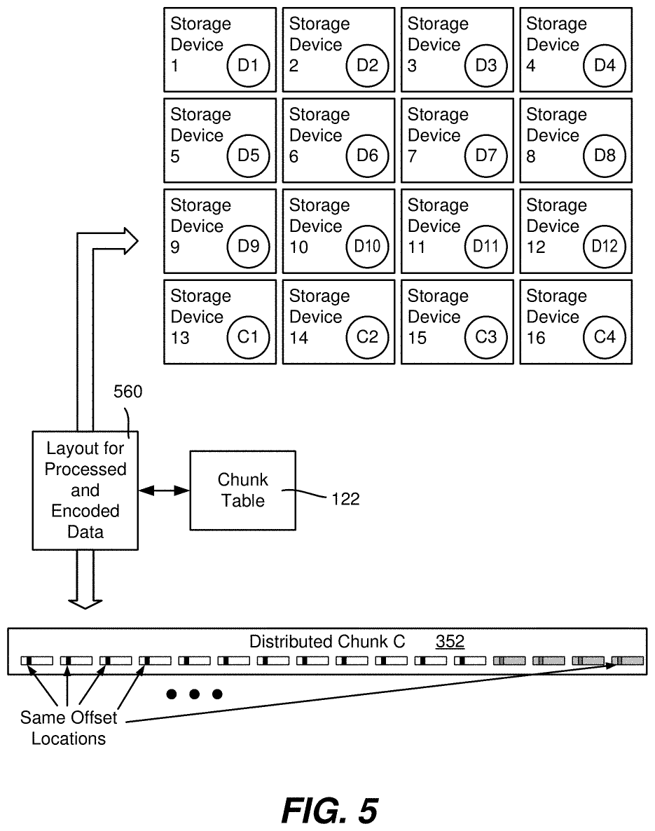

FIG. 5 shows an example of how the twelve data fragments D1-D12 and four coding fragments C1-C4 of the distributed chunk C 352 can be stored on storage devices 1-16, which can be separate nodes, disks, solid state drives and so on. The way the coding of k data fragments+m coding fragments is done assures that the system can tolerate the loss of any m fragments, where m=4 coding fragments in this example and k=12 data fragments.

A distributed data chunk such as the distributed data chunk C 350 can be pre-allocated/laid out (block 560) in advance; once laid out, the destination chunks can be encoded on-the-fly (there is no need to use any preliminary protection scheme as the data is already protected within the inbox chunks). In one implementation, as the data fragments (unshaded) and coding fragments (shaded) are written, they are appended to any previously written data fragments and coding fragments in chunk data structures distributed among the storage devices. Because fragments are the same size, the offsets for each group of written segments are the same in each of the chunk data structures. Note that the distribution means that the data is directly protected via erasure coding once the writes of a group of data and coding segments are complete. At such a time, the preliminarily protected object data can be deleted (or marked for subsequent deletion as no longer being live data); once a preliminarily protected chunk contains no live data, the chunk and its mirrored copies can be deleted and its space reclaimed.

To summarize the above example of FIG. 3, the thirty data segments of the three data objects 224(1)-224(3) from the two source inbox chunks A and B (220(A) and 220B)) have been processed (consolidated and compressed) to form three contiguous and compressed data portions 324(1)-324(3) that fit into just one destination chunk space 340, corresponding to one distributed chunk C 352. Benefits include improved data locality via the consolidation; for example, if object 1 is later deleted of object 1, a considerable part of distributed chunk C 352 can be reclaimed as a single piece. Benefits also include that the amount of capacity occupied by the three objects has been reduced by a half in this example.

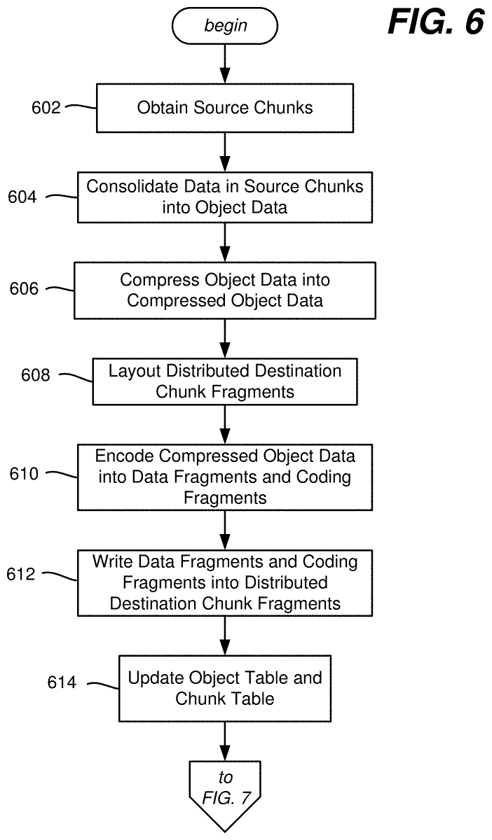

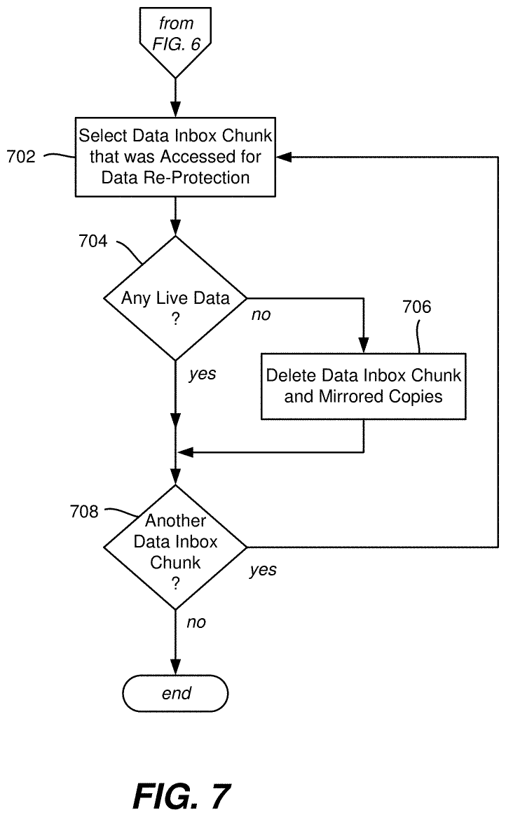

FIGS. 6 and 7 comprise a flow diagram summarizing example operations as descried herein, beginning at operation 602 where the source chunks (information of the data inbox chunks) are obtained. It should be noted that the size of objects is known via the object table, and thus a group of objects can be chosen so as to fit (e.g., following compression) into a chunk space, with the chosen objects used to determine which preliminarily protected chunks are the source data inbox chunks.

Operation 604 consolidates the object data from the source chunk(s) into the consolidated object data as described with reference to FIGS. 2 and 3. Operation 606 compresses the consolidated object data into compressed object data as described with reference to FIGS. 3 and 4.

Operation 610 represents the encoding of the compressed object data into the data fragments and coding fragments, which are written to the fragment space of a distributed destination chunk at operation 612. Operation 614 represents system metadata management, which includes updating the object table and chunk table.

With respect to system metadata management, for example, the object table 116 keeps track of the objects within the data storage system, while the chunk table keeps track of the chunks within the data storage system. If used, the index 226 of recently created objects is also updated.

In general, live object data in a data inbox chunk is moved from the old chunk(s) to a new chunk. Whenever this occurs, the object location information in the object table is updated accordingly, as is the chunk table to accommodate each new chunk. After the live data is moved from an old chunk, the old chunk is removed from the chunk table.

Thus, when new objects are stored to the data inbox space, they are stored to chunks registered in the chunk table, and the object location information is stored to the object table. When the object data is processed during chunk re-protection as described herein, the processed data (live data) is moved to new chunks registered in the chunk table; the object location information in the object table is overwritten and information about old (data inbox) chunks is removed from the chunk table when no live data remains to be moved.

FIG. 7 represents example operations that delete a data inbox chunk that has no live data after the data re-protection of FIG. 6 is performed. This can also be done in a separate garbage collection operation.

In the example of FIG. 7, a data inbox chunk that was accessed for object data to be re-protected can be selected (operation 702) to determine whether that data inbox chunk has any remaining live data. If not, operation 706 deletes the data inbox chunk and its mirrored copies. Operation 708 repeats the process for other data inbox chunks from which object data was removed for processing and re-protection as described herein.

As can be seen, described is a technology that increases data storage efficiency without a significant impact on write performance. The technology can work with data chunks that are initially protected (e.g., with triple mirroring), in which the data storage system returns to the preliminarily protected data chunks to perform data re-protection using erasure coding. Such data chunks protected with the preliminary protection scheme thus form a data inbox for future processing.

Described herein is additional processing of such data before re-protection. This provides an advantage of inline data processing (efficient permanent storage of data) without the disadvantage of inline data processing (low write performance). Processing recently created data can include consolidation of the object data stored to different inbox chunks or to different parts of one inbox chunk, which improves data locality. The consolidated data can be stored to a sequence of destination chunks, which are to be protected directly with erasure coding.

Further processing can include compressing the data. The data storage system creates a set of destination chunks to stream the consolidated and compressed objects to the destination chunks. Such chunks can be dedicated for data inbox processing, that is, in one or more implementations, data that is being processed as described herein do not share chunks with new data that is being created.

In sum, although there are various ways to implement the technology, object-driven data processing is used in one implementation, in which recently created (or updated) objects are read, consolidated, compressed, and stored in new chunks protected directly with erasure coding. After the objects that have data in an inbox chunk have been processed, the input chunk can be deleted so its capacity can be reclaimed and reused.

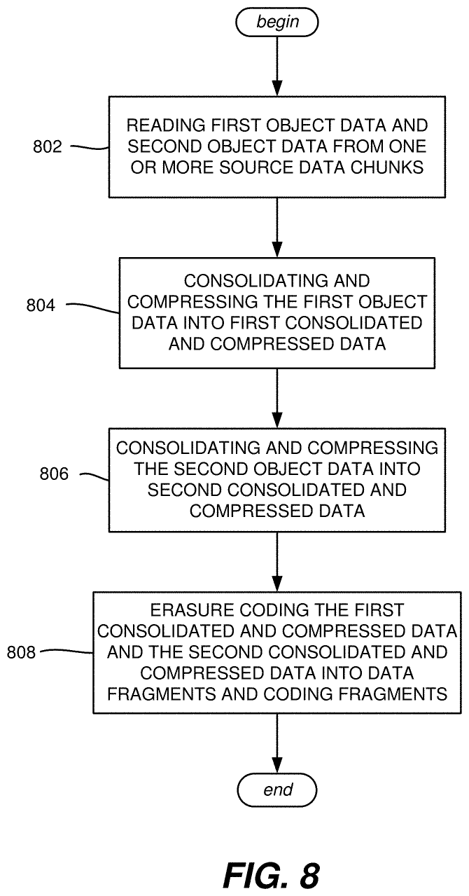

One or more aspects are represented in FIG. 8, such as of a system comprising a processor, and a memory that stores executable instructions that, when executed by the processor, facilitate performance of operations. Operation 802 represents reading first object data and second object data from one or more source data chunks. Operation 804 represents consolidating and compressing the first object data into first consolidated and compressed data. Operation 806 represents consolidating and compressing the second object data into second consolidated and compressed data. Operation 808 represents erasure coding the first consolidated and compressed data and the second consolidated and compressed data into data fragments and coding fragments.

Further operations can comprise storing the data fragments and coding fragments in a destination data chunk distributed among storage devices. Further operations can comprise pre-allocating space for the data fragments and the coding fragments of the destination data chunk distributed among the storage devices.

Further operations can comprise updating metadata to represent stored location data for the first object data and the second object data corresponding to the destination data chunk.

The storage devices can comprise cluster nodes. The storage devices can comprise at least one of hard disk drives or solid state storage devices on one or more cluster nodes.

Further operations can comprise deleting the one or more source data chunks. The one or more source data chunks can be protected via a mirroring-based preliminary protection process applicable to the one or more source data chunks and one or more mirrored copies of the one or more source data chunks; further operations can comprise deleting the one or more source data chunks and deleting the or more mirrored copies of the one or more source data chunks.

Further operations can comprise reading third object data from the one or more source data chunks, consolidating and compressing the third object data into third consolidated and compressed data, and erasure coding the third consolidated and compressed data into the data fragments and the coding fragments in conjunction with the erasure coding the first consolidated and compressed data and the second consolidated and compressed data.

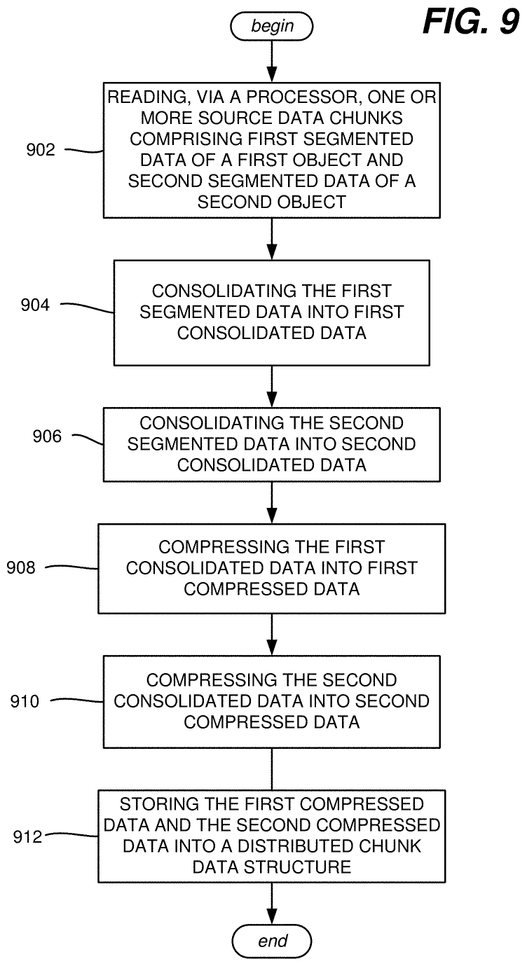

One or more aspects are represented in FIG. 9, such as example operations of a method. Operation 902 represents reading, via a processor, one or more source data chunks comprising first segmented data of a first object and second segmented data of a second object. Operation 904 represents consolidating the first segmented data into first consolidated data. Operation 906 represents consolidating the second segmented data into second consolidated data. Operation 908 represents compressing the first consolidated data into first compressed data. Operation 910 represents compressing the second consolidated data into second compressed data. Operation 912 represents storing the first compressed data and the second compressed data into a distributed chunk data structure.

Aspects can comprise updating metadata to represent stored location data for the first object data and the second object data in the distributed chunk data structure.

Aspects can comprise deleting the one or more source data chunks.

Aspects can comprise erasure coding the first compressed data and the second compressed data into data fragments and coding fragments, and wherein the storing the first compressed data and the second compressed data into the distributed chunk data structure comprises storing the data fragments and coding fragments.

Aspects can comprise pre-allocating space for the data fragments and the coding fragments of the destination chunk data structure.

Aspects can comprise reading third segmented data of a third object from the one or more source data chunks, consolidating the third segmented data into third consolidated data, compressing the third consolidated data into third compressed data, and erasure coding the first compressed data, the second compressed data and the third compressed data into data fragments and coding fragments, and wherein the storing the first compressed data and the second compressed data into the distributed chunk data structure comprises storing the data fragments and coding fragments.

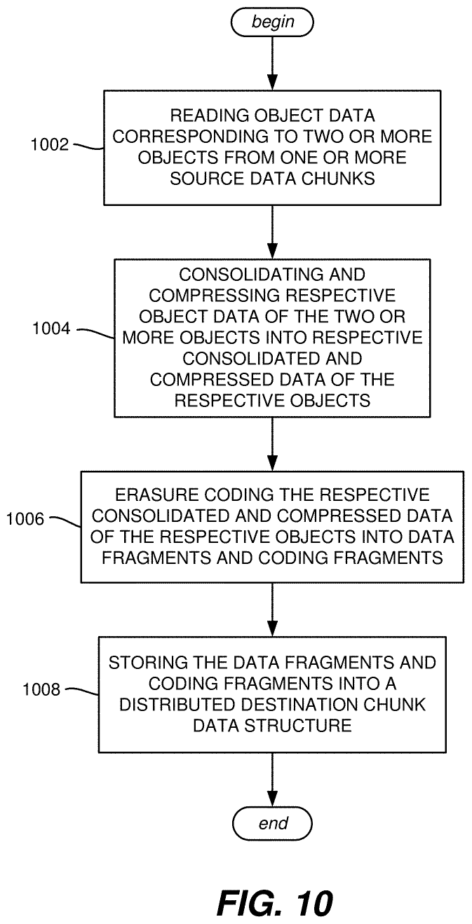

One or more aspects, such as implemented in a machine-readable storage medium, comprising executable instructions that, when executed by a processor of a data storage system, can be directed towards operations exemplified in FIG. 10. Example operation 1002 represents reading object data corresponding to two or more objects from one or more source data chunks. Example operation 1004 represents consolidating and compressing respective object data of the two or more objects into respective consolidated and compressed data of the respective objects. Example operation 1006 represents erasure coding the respective consolidated and compressed data of the respective objects into data fragments and coding fragments. Example operation 1008 represents storing the data fragments and coding fragments into a distributed destination chunk data structure.

Further operations can comprise pre-allocating data fragment space and coding fragment space of the distributed destination chunk data structure on distributed storage devices. Pre-allocating the data fragment space and coding fragment space of the distributed destination chunk data structure on the distributed storage devices can comprise pre-allocating the data fragment space and coding fragment space on different cluster nodes, or pre-allocating the data fragment space and coding fragment space on different storage devices of one or more cluster nodes.

The one or more source data chunks can be protected via a triple mirroring preliminary protection scheme, which can comprise two additional copies of each of the one or more source data chunks; further operations can comprise determining that a given source data chunk has had object data therein protected via erasure coding, and deleting the given source data chunk and two additional copies of the given source data chunk.

Further operations can comprise updating metadata to represent stored locations of the two or more objects in the distributed destination chunk data structure.

As can be seen, described herein is a technology that facilitates consolidating and compressing data without a significant impact on write performance when re-protecting data with erasure coding instead of via a preliminary protection scheme. The same technology can be adapted to perform similar data processing, e.g. to de-duplicate recently created data. The technology is practical to implement.

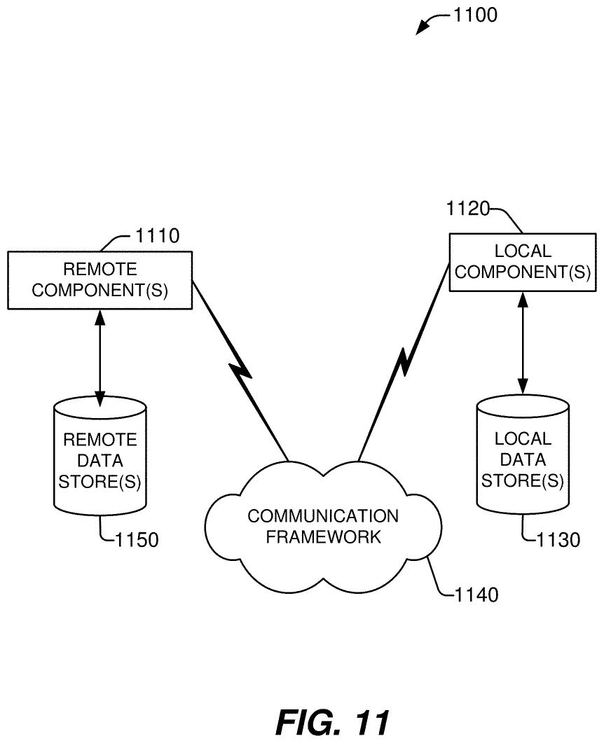

FIG. 11 is a schematic block diagram of a computing environment 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate/use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

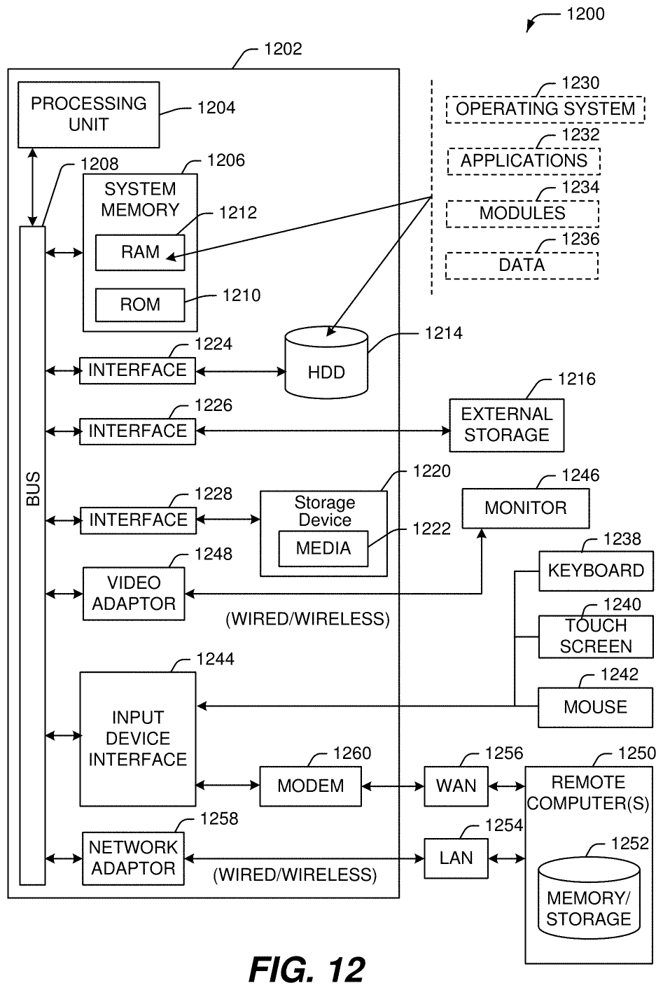

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), and can include one or more external storage devices 1216 (e.g., a magnetic floppy disk drive (FDD) 1216, a memory stick or flash drive reader, a memory card reader, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214.

Other internal or external storage can include at least one other storage device 1220 with storage media 1222 (e.g., a solid state storage device, a nonvolatile memory device, and/or an optical disk drive that can read or write from removable media such as a CD-ROM disc, a DVD, a BD, etc.). The external storage 1216 can be facilitated by a network virtual machine. The HDD 1214, external storage device(s) 1216 and storage device (e.g., drive) 1220 can be connected to the system bus 1208 by an HDD interface 1224, an external storage interface 1226 and a drive interface 1228, respectively.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather is to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
reading first object data and second object data from one or more source data chunks;
consolidating and compressing the first object data into first consolidated and compressed data;
consolidating and compressing the second object data into second consolidated and compressed data; and
erasure coding the first consolidated and compressed data and the second consolidated and compressed data into data fragments and coding fragments.

2. The system of claim 1, wherein the operations further comprise storing the data fragments and coding fragments in a destination data chunk distributed among storage devices.

3. The system of claim 2, wherein the operations further comprise pre-allocating space for the data fragments and the coding fragments of the destination data chunk distributed among the storage devices.

4. The system of claim 2, wherein the operations further comprise updating metadata to represent stored location data for the first object data and the second object data corresponding to the destination data chunk.

5. The system of claim 2, wherein the storage devices comprise cluster nodes.

6. The system of claim 2, wherein the storage devices comprise at least one of hard disk drives or solid state storage devices on one or more cluster nodes.

7. The system of claim 1, wherein the operations further comprise deleting the one or more source data chunks.

8. The system of claim 1, wherein the one or more source data chunks are protected via a mirroring-based preliminary protection process applicable to the one or more source data chunks and one or more mirrored copies of the one or more source data chunks, and wherein the operations further comprise deleting the one or more source data chunks and deleting the or more mirrored copies of the one or more source data chunks.

9. The system of claim 1, wherein the operations further comprise reading third object data from the one or more source data chunks, consolidating and compressing the third object data into third consolidated and compressed data, and erasure coding the third consolidated and compressed data into the data fragments and the coding fragments in conjunction with the erasure coding the first consolidated and compressed data and the second consolidated and compressed data.

10. A method, comprising,
reading, via a processor, one or more source data chunks comprising first segmented data of a first object and second segmented data of a second object;
consolidating the first segmented data into first consolidated data;
consolidating the second segmented data into second consolidated data;
compressing the first consolidated data into first compressed data;
compressing the second consolidated data into second compressed data; and
storing the first compressed data and the second compressed data into a distributed chunk data structure.

11. The method of claim 10, further comprising updating metadata to represent stored location data for the first object data and the second object data in the distributed chunk data structure.

12. The method of claim 10, further comprising deleting the one or more source data chunks.

13. The method of claim 10, further comprising erasure coding the first compressed data and the second compressed data into data fragments and coding fragments, and wherein the storing the first compressed data and the second compressed data into the distributed chunk data structure comprises storing the data fragments and coding fragments.

14. The method of claim 13, further comprising pre-allocating space for the data fragments and the coding fragments of the destination chunk data structure.

15. The method of claim 10, further comprising reading third segmented data of a third object from the one or more source data chunks, consolidating the third segmented data into third consolidated data, compressing the third consolidated data into third compressed data, and erasure coding the first compressed data, the second compressed data and the third compressed data into data fragments and coding fragments, and wherein the storing the first compressed data and the second compressed data into the distributed chunk data structure comprises storing the data fragments and coding fragments.

16. A non-transitory machine-readable medium, comprising executable instructions that, when executed by a processor of a data storage system, facilitate performance of operations, the operations comprising:
reading object data corresponding to two or more objects from one or more source data chunks;
consolidating and compressing respective object data of the two or more objects into respective consolidated and compressed data of the respective objects;
erasure coding the respective consolidated and compressed data of the respective objects into data fragments and coding fragments; and
storing the data fragments and coding fragments into a distributed destination chunk data structure.

17. The non-transitory machine-readable medium of claim 16, wherein the operations further comprise pre-allocating data fragment space and coding fragment space of the distributed destination chunk data structure on distributed storage devices.

18. The non-transitory machine-readable medium of claim 17, wherein the pre-allocating the data fragment space and coding fragment space of the distributed destination chunk data structure on the distributed storage devices comprises pre-allocating the data fragment space and coding fragment space on different cluster nodes, or pre-allocating the data fragment space and coding fragment space on different storage devices of one or more cluster nodes.

19. The non-transitory machine-readable medium of claim 16, wherein the one or more source data chunks are protected via a triple mirroring preliminary protection scheme comprising two additional copies of each of the one or more source data chunks, and wherein the operations further comprise determining that a given source data chunk has had object data therein protected via erasure coding, and deleting the given source data chunk and two additional copies of the given source data chunk.

20. The non-transitory machine-readable medium of claim 16, wherein the operations further comprise updating metadata to represent stored locations of the two or more objects in the distributed destination chunk data structure.
